(19) United States
(12) Patent Application Publication
(10) Pub. No.: US 2014/0005843 A1
(43) Pub. Date: Jan. 2, 2014

(54) IRRIGATION SYSTEM

(71) Applicant: Ian Thomas, New South Wales (AU)

(72) Inventor: Ian Thomas, New South Wales (AU)

(73) Assignee: Pandeb Holdings Pty Ltd, New South Wales (AU)

(21) Appl. No.: 13/883,952

(22) PCT Filed: Oct. 28, 2011
(86) PCT No.: PCT/AU2011/001387

§ 371 Date: Jul. 18, 2013

Related U.S. Application Data
(60) Provisional application No. 61/429,516, filed on Jan. 4, 2011.

(30) Foreign Application Priority Data
Nov. 8, 2010 (AU) 2010904955

(51) Int. Cl. A01G 25/16; H01Q 1/04

(52) U.S. Cl. CPC A01G 25/16; H01Q 1/04
USPC 700/284; 343/719

(57) ABSTRACT

The present disclosure relates to an irrigation system comprising a surface wave launcher located predominantly underground and controlled by an electronic control system, and a surface wave receiver located underground and operatively coupled to an irrigation sprinkler. In operation, the surface wave launcher is activated by the electronic control system to, under predetermined conditions, transmit a surface wave signal. The surface wave signal is transmitted at a relatively low operating frequency and received by the surface wave receiver to activate the irrigation sprinkler.

### PRIORITY CLAIM

This application is a national stage application of PCT/AU2011/001387, filed on Oct. 28, 2011, which claims the benefit of and priority to Australian Patent Application No. 2010904955, filed on Nov. 8, 2010, and which claims the benefit of and priority to U.S. Provisional Patent Application No. 61/429,516, filed on Jan. 4, 2011, the entire contents of which are each incorporated by reference herein.

### BACKGROUND

There are presently two known varieties of irrigation control systems (i.e., controller/satellite systems and decoder-style systems) and both are dependent on hard wiring and thus subject to the effect of electrical surges caused by lightning events. As such, both systems can be damaged by these events and are subject to maintenance and repairs after these events.

(a) Controller/Satellite System

These systems incorporate host controllers either centrally located or located throughout the course in what is known as a satellite system. Sprinklers or solenoid-actuated control valves are actuated via a 24V signal which is transmitted through copper wiring of which there may be up to 200 km. Communication to the remote satellites from a central computer may be also by hard wire.

(b) Decoder-Style System

These systems run from a single cable (or multiple cables called legs) running throughout the course. It can be either two or three wires and these wires are used for both power and communication. As such, these systems, with damage in one area, can shut the whole system down until repaired.

### SUMMARY

The present disclosure relates broadly to an irrigation system such as that used to reticulate a golf course. The disclosure also relates to a surface wave launcher and more particularly a surface wave launcher used to remotely control an irrigation system via a surface wave signal.

According to one aspect of, the present disclosure there is provided an irrigation system comprising:
a surface wave launcher adapted or configured to locate predominantly underground and to be controlled by an electronic control system to, under predetermined conditions, transmit a surface wave signal at a relatively low operating frequency; and
a surface wave receiver adapted or configured to locate underground and operatively couple to an irrigation sprinkler to activate the sprinkler responsive to the low frequency surface wave signal.

In various embodiments, the surface wave launcher is adapted to locate predominantly just below the surface of the ground to effectively launch a ground component of the surface wave. In one such embodiment, the surface wave launcher includes a driven monopole which is located slightly below the surface of the ground with its driven end at or near the surface of the ground.

In various embodiments, the electronic control system includes a surface wave launcher controller operatively coupled to the surface wave launcher to send the surface wave signal to activate at least one of a plurality of the irrigation sprinklers. In one such embodiment, the surface wave signal includes a unique identifier which corresponds to said one of the plurality of sprinklers which activates in response to the surface wave signal. In one such embodiment, the surface wave launcher controller is adapted to couple to a central controller or a satellite controller which under the predetermined conditions sends an electronic control signal to the surface wave launcher controller to instruct the surface wave launcher to send the surface wave signal to the plurality of sprinklers.

In various embodiments, the surface wave launcher includes a plurality of conductors connected in series in a meander line configuration. In one such embodiment, the surface wave launcher also includes an opposing pair of grid elements each providing a series of connections for the plurality of conductors which connect between the opposing pair of grid elements. In one embodiment, the plurality of conductors are arranged in an inner and outer array spaced longitudinally by the pair of opposing grid elements and separated radially or laterally by an electromagnetic screen.

In various embodiments, the surface wave receiver is mounted to the irrigation sprinkler. In one such embodiment, the surface wave receiver includes a rod antenna element such as a ferrite rod which detects the magnetic field of the surface wave signal. Alternatively, the surface wave receiver is of a serpentine configuration of conductors to permit both receiving and transmitting capabilities. In this alternate arrangement the surface wave receiver is configured to communicate wirelessly with the surface wave launcher.

According to another aspect of the disclosure, there is provided a surface wave launcher comprising:
a plurality of conductors connected in series in a meander line configuration;
an opposing pair of grid elements each providing a plurality of connections configured to interconnect the plurality of conductors which connect between the opposing pair of grid elements to form an outer and inner array of the conductors; and
an electromagnetic screen located between the outer and inner arrays.

In various embodiments, the outer and inner arrays of the plurality of conductors are arranged concentric with one another. In one such embodiment, the concentric outer and inner arrays are separated by the electromagnetic screen which is shaped cylindrical. In one embodiment, the cylindrical electromagnetic screen is arranged concentric with the concentric outer and inner arrays of the plurality of conductors.

In various embodiments, the opposing pair of grid elements each include a printed circuit board having the plurality of connections configured to interconnect the inner and outer arrays of the plurality of conductors in series.

In various embodiments, the surface wave launcher also comprises a ground plate which is electrically connected to the electromagnetic screen at or adjacent one of the grid elements. In one such embodiment, the surface wave launcher further comprises a capacitive loading plate which is electrically connected to another of the conductors at or adjacent the opposing grid element. In one embodiment, the respective conductors connected to a first driven element and the capacitive loading plate are both located in the outer array of the conductors.

In various embodiments, the surface wave launcher is configured to launch the surface wave signal across the air/ground boundary or interface where it remains coupled as an electromagnetic signal.

In various embodiments, the relatively low operating frequency of the surface wave launcher is between 3 and 30 MHz and more particularly 13.56 MHz. The 3 to 30 MHz operating frequency is in the HF or High Frequency part of the electromagnetic spectrum.

In various embodiments, the surface wave receiver is either directly coupled to the sprinkler or coupled to one or more of the sprinklers via a control valve such as a solenoid-actuated valve.

It is to be understood that the surface wave signal is an electromagnetic signal.

Additional features and advantages are described in, and will be apparent from the following Detailed Description and the figures.

### BRIEF DESCRIPTION OF THE DRAWINGS

In order to achieve a better understanding of the nature of the present disclosure, one embodiment of an irrigation system and a surface wave launcher will now be described, by way of example only, with reference to the accompanying drawings in which:

FIG. 1 is a schematic overview of an embodiment of an irrigation system according to the present disclosure;

FIG. 2 is a schematic illustration of part of the irrigation system of FIG. 1 and more particularly a satellite controller together with its associated surface wave launcher and irrigation sprinklers;

FIG. 3 is a perspective view of part of a surface wave launcher such as that taken from the irrigation system of FIGS. 1 and 2;

FIG. 4 is a part exploded and part cut-away view of the surface wave launcher of FIG. 3;

FIG. 5 is a schematic circuit diagram for a surface wave launcher controller such as that fitted to the satellite controller of the irrigation system of FIGS. 1 and 2; and

FIG. 6 is a schematic circuit diagram of a surface wave receiver controller such as that fitted to the irrigation sprinklers of the irrigation system of FIGS. 1 and 2.

### DETAILED DESCRIPTION

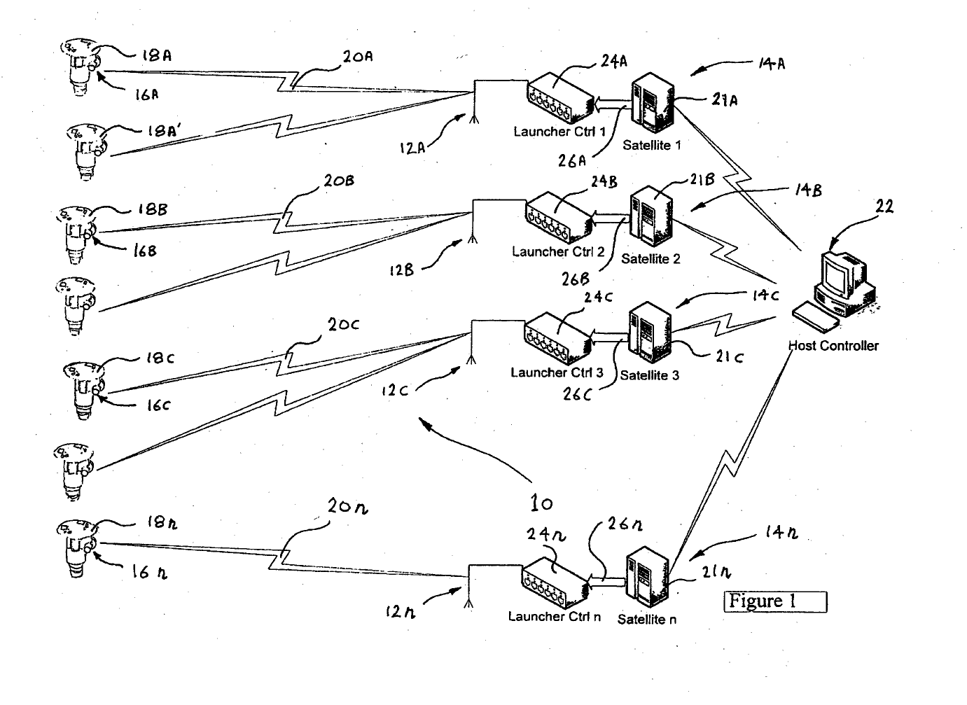

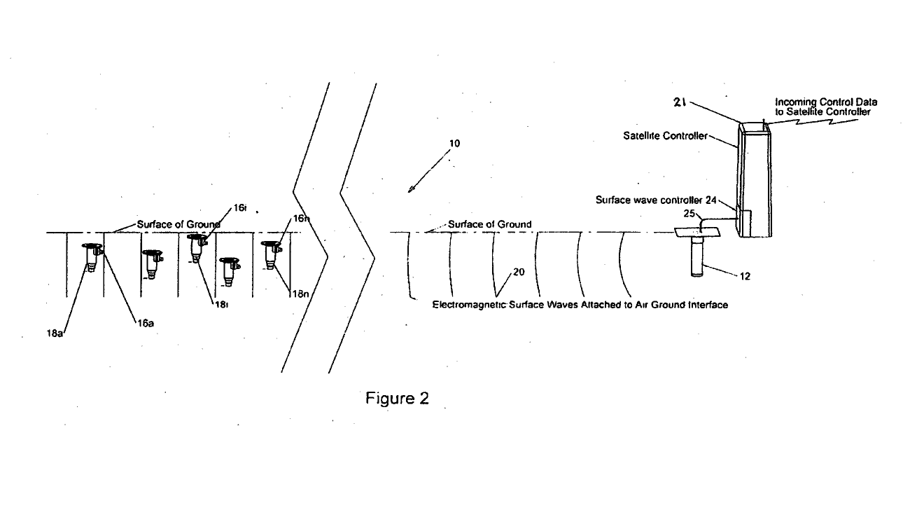

As best shown in FIGS. 1 and 2, there is an irrigation system designated generally as 10 comprising a surface wave launcher 12 located predominantly underground and controlled by an electronic control system 14, and a surface wave receiver 16 located underground and operatively coupled to an irrigation sprinkler such as 18A. In operation, the surface wave launcher 12 is activated by the electronic control system 14 to, under predetermined conditions, transmit a surface wave signal 20 designated schematically by the broken line or wave front of FIG. 1 or 2 respectively. The surface wave signal 20 is transmitted at a relatively low operating frequency and received by the surface wave receiver 16 to activate the irrigation sprinkler such as 18A.

In various embodiments, the disclosure employs surface waves to communicate between the surface wave launcher 12 and the surface wave receiver 16. This is a propagating electromagnetic wave where the energy used to communicate between these devices is not radiated into free space but instead is launched onto the air/ground boundary or surface of the earth where it remains bound and coupled and is understood to propagate at a speed slightly slower than the speed of light. The surface wave launcher such as 12 includes a driven monopole (not shown) which is at least in part buried to effectively couple the surface wave 20 to the air/ground interface. In this embodiment there is nothing visible of the surface wave launcher 12 except for a monopole ground plane on the surface.

The surface wave signal such as 20 can be transmitted at a range of operating frequencies provided the surface wave receiver such as 16A which is located underground receives an underground component of the surface wave signal 20 to activate its corresponding irrigation sprinkler such as 18A. The surface wave launcher such as 12A will effectively operate at relatively low frequencies of between 3 and 30 MHz and more particularly at an ISM frequency of 13.56 MHz. This relatively low frequency ensures that a proper surface is generated but avoids typical commercial frequencies which otherwise require regulatory approval (e.g., via the regulatory bodies of the Australian Communications and Media Authority (“ACMA”) and the Federal Communications Commission (“FCC”)). The surface waves propagate along the air/ground boundary and because there is only a small component of the signal in the air it is understood that compliance with the ACMA, FCC or other regulator requirements is not required. The surface wave launchers and receivers such as 12 and 16 should be tuned to the intended operating frequency with a bandwidth of about 5% or around 600 kHz at the ISM frequency. The 3 to 30 MHz operating frequency is in the HF or High Frequency part of the electromagnetic spectrum. In this embodiment with the launcher 12 and the receiver 16 buried it is the subsurface component of the surface wave which is utilized.

As shown in FIG. 1, in this embodiment the electronic control system includes one of a plurality of satellite controllers such as 21A to 21n wirelessly communicating with a host controller 22. In a typical installation for an 18-hole golf course, there will be 18 satellites 21A to 21R dedicated to respective of the holes. Each of the satellite controllers such as 21A typically includes eight output cards (not shown), each having eight output ports (not shown) together providing a total of 64 inputs/outputs (or stations) on a data bus designated generally as 26A for each of the satellites such as 21A. It should be understood that the satellite controller can include more or less stations depending on the supplier & particular installation. The 64 inputs/outputs (or stations) are in this embodiment connected to a common surface wave launcher controller such as 24A. The surface wave launcher controller 24A is in this example connected to the corresponding surface wave launcher 12A via an interconnect cable 25 (see FIG. 2). In an alternate configuration the system has no satellite controllers and the surface wave launchers are controlled directly by a central controller or computer.

The irrigation system 10 is configured so that the surface wave launcher controller 24 under the predetermined conditions instructs the surface wave launcher such as 12A to send the surface wave signal such as 20 to activate at least one of the plurality of the irrigation sprinklers such as 18A and 18B. The surface wave signal such as 20 includes a unique identifier which corresponds to at least one of the plurality of sprinklers such as 18A. This irrigation sprinkler 18A and any other sprinklers having that unique identifier thus activate in response to the surface wave signal such as 20. In one embodiment, the predetermined conditions under which the surface wave signal 20 is transmitted to activate the relevant sprinkler such as 18A include specific times of day at which irrigation is to be effected.

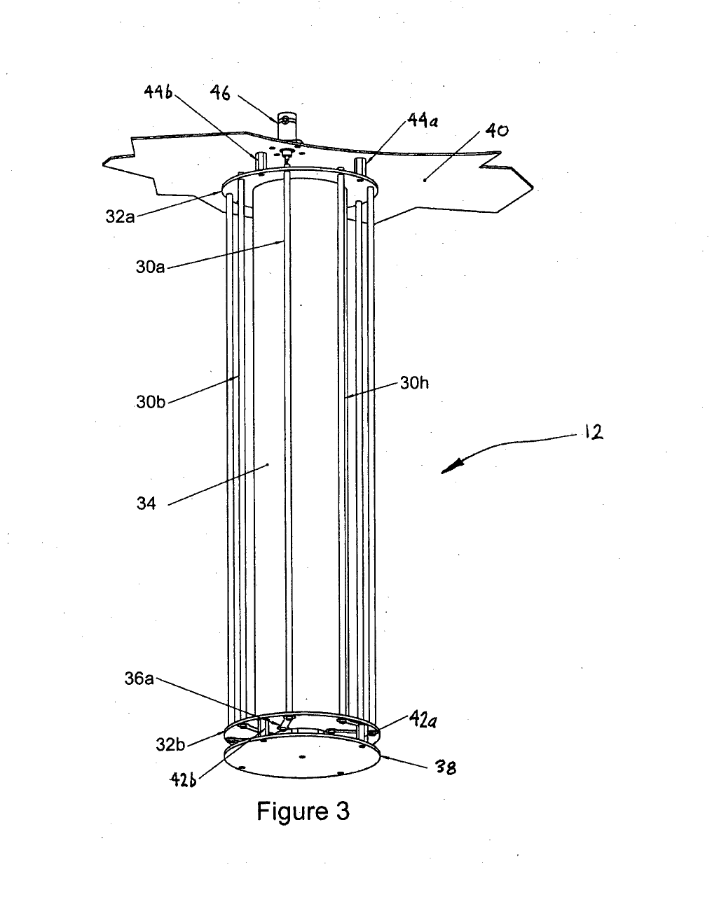

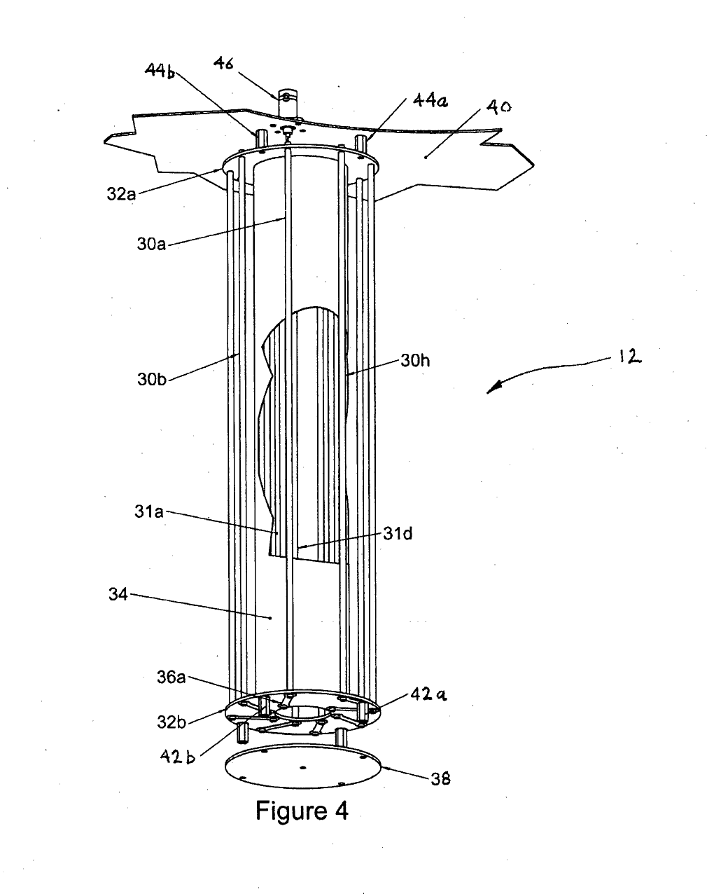

FIGS. 3 and 4 are perspective views of a surface wave launcher such as 12 (with its waterproof canister removed) according to another aspect of the present disclosure. The surface wave launcher 12 comprises a plurality of conductors 30a to 30h and 31a to 31h interconnected by a pair of opposing grid elements 32a and 32b. The conductors 30a to 30h and 31a to 31h are in this embodiment arranged in respective inner and outer arrays (see FIG. 4) separated by an electromagnet screen 34. In this embodiment, the conductors such as 30a are of equal length and at opposing ends connected to respective of the pair of grid elements 32a and 32b via a plurality of connections such as 36a. The connections such as 36a are configured to connect one of the conductors such as 30a located in the outer array to another of the conductors such as 31a located in the inner array. Sequentially the opposite end of the conductor 30a is connected by an electrical connection on the opposite grid element or plate 32a to the appropriate end of the next conductor 31a. The conductors such as 30a are each in the form of a conducting rod. The outer and inner arrays of conductors 30a to 30h and 31a to 31h are thus connected in a series in a meander line configuration.

The inner and outer arrays of the conductors 30a to 30h and 31a to 31h are in this embodiment arranged concentric with one another. The electromagnetic screen 34 is shaped cylindrical and also arranged concentric with the concentric inner and outer arrays of the conductors 30a to 30h and 31a to 31h. In this example, the pair of grid elements are conveniently shaped circular and in the form of a printed circuit board having the plurality of connections such as 36a for interconnection of the conductors such as 30a and 31a in series. Further, the grid elements or plates 32a/b provide mechanical support for all conductors and the electromagnetic screen 34.

The surface wave launcher 12 is mounted between a capacitive loading plate 38 and a launcher base plate or ground plate 40 mounted adjacent respective of the pair of grid elements 32a and 32b. Spacer elements such as 42a and 44b separate the capacitive loading plate 38 and the ground plate 40 from their respective grid plates 32a and 32b. A launcher input coaxial connector 46 is connected to the ground plate 40. The outer conductor 30a connected to the input connector 46 is thus electrically connected to the ground plate 40. The inner driven conductor may connect either directly to the first conductor 30a of the outer array or pass through a matching component before connecting to the conductor 30a. The capacitive loading plate is in the form of a conducting disc 38 mounted on the spacers such as 42a electrically insulated from the rest of the assembly. The last of the conductors 30h located in the outer array connects to the capacitive loading plate 38 via one of the spacer elements. The electromagnetic screen 34 shields all of the conductors such as 31a located in the inner array from interfering with radiation of other conductors such as 30a located in the outer array. The last or eighth of the conductors 30h located in the outer array connects to the capacitive loading plate via one of the spacer elements such as 42b.

The surface wave receiver 16 of this embodiment employs a rod magnetic field antenna constructed of a suitable magnetic material or ferrite which operates with the magnetic components of the surface wave signal. It is understood that this type of receiving device operates well as a receiver but functions poorly in the reciprocal transmitting mode. Alternately, the surface wave receiver 16 may be of a serpentine or meander line type configuration which with the intermediate electromagnetic screen lends itself to both receiving and transmitting capabilities. This configuration provides that the surface wave receiver functions to not only receive the surface wave signal to trigger the corresponding irrigation sprinkler but also to communicate wirelessly with the surface wave launcher or other remote device, for example to confirm activation of the sprinkler or for remote diagnostics. This wireless communication may also enable for data transmission of sensor readings such as soil temperature and soil moisture content.

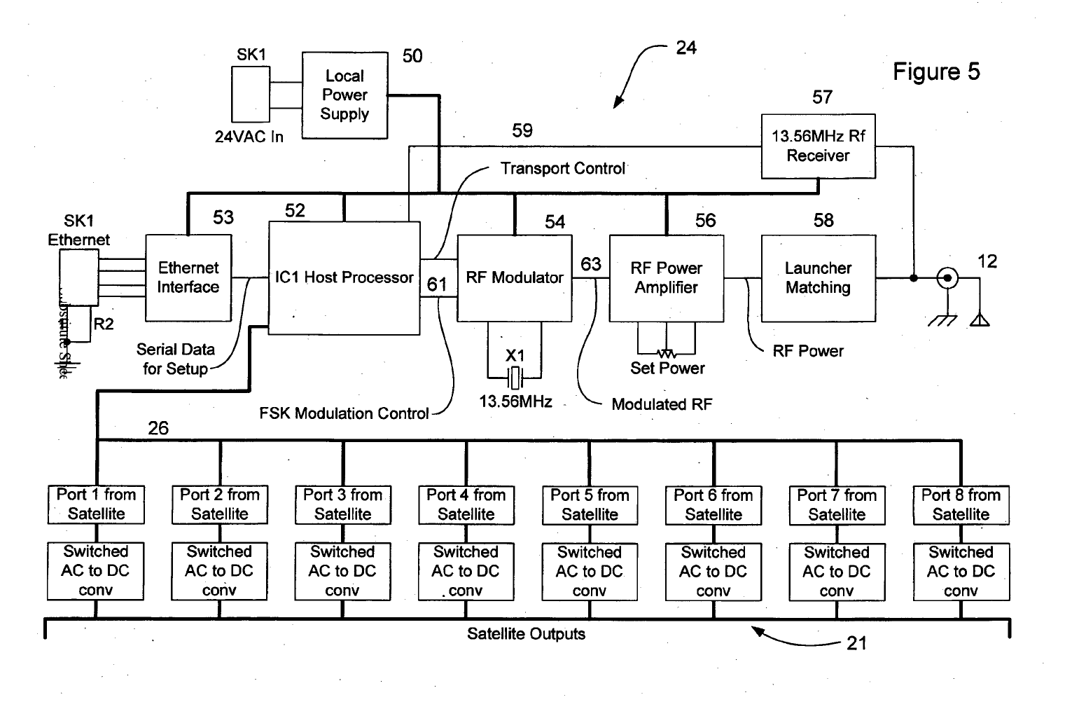

FIG. 5 is a schematic circuit diagram for the surface wave launcher controller 24 such as that connected or fitted to the satellite controller such as 21A of the irrigation system 10 of FIGS. 1 and 2. The top half of FIG. 5 shows more particularly the electronics of the surface wave launcher controller 24 whereas the bottom half merely depicts the output cards/ports of the corresponding satellite controller such as 21A.

The surface wave launcher controller 24 in this example is powered by a local 24 VAC power supply 50. The satellite data bus 26 communicates with a host processor 52 which is programmed with the appropriate codes (including a unique ID) for the various sprinklers it controls via an Ethernet interface 53. The host processor 52 is loaded with lookup tables which convert information from the satellite controller's “one of many” outputs to a unique identifier code which corresponds to the sprinkler the satellite controller wishes to activate or shut down such as 18A and 18B. The surface wave launcher controller 24 also includes an RF modulator 54, an RF power amplifier 56 and a launcher matching unit 58 which together send a suitably encrypted signal to the surface wave launcher 12. This occurs when the host controller 52 detects a change of state on any of the addressable inputs/outputs (or stations) on the data bus 26 corresponding to the satellite controller such as 21A signalling to turn a sprinkler such as 18A on or off. Before initiating any action the surface wave controller examines an analog input line 59 on a collision avoidance receiver 57 to ensure no other surface wave launcher is operating. This in effect forms a CSMA system

The host controller 52 then switches a Frequency Shift Keyed (FSK) modulation control line 61 to generate an encrypted code for the required sprinkler such as 18A including a command to turn it on or off. An RF modulator 54 connected to the control line 61 generates a stabilised FSK signal 63. This FSK encrypted signal 63 is amplified by an RF power amplifier 56 to generate a sufficiently strong signal to reach all sprinklers such as 18A reliably. A launcher matching unit 58 connects the power amplifier 56 to the surface wave launcher 12.

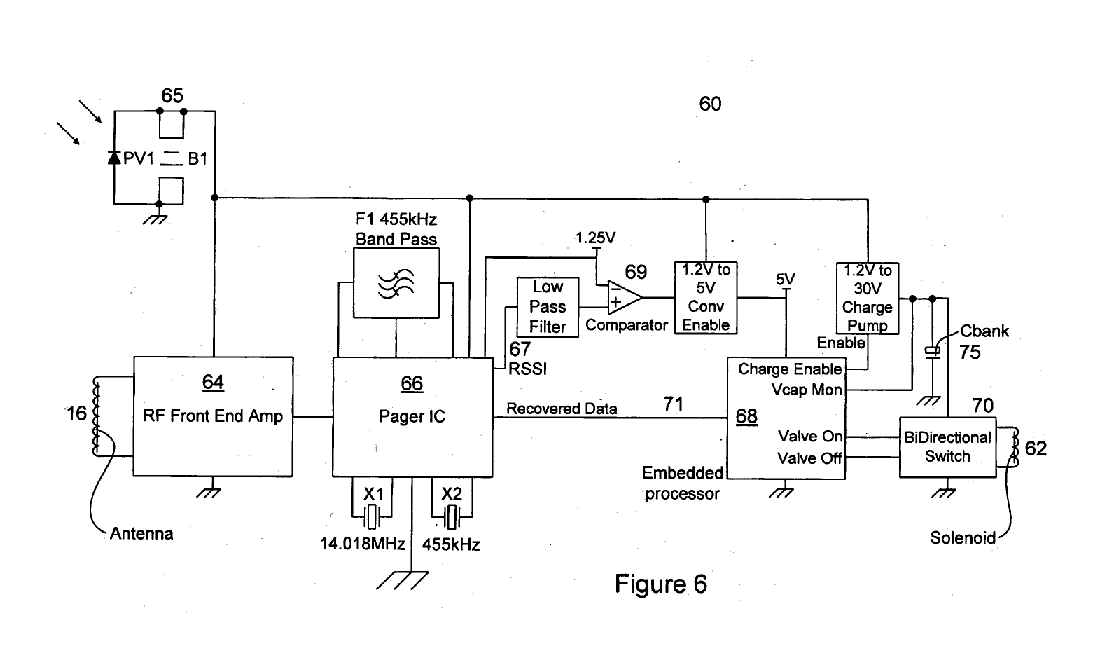

FIG. 6 is a schematic circuit diagram of a surface wave receiver controller 60 such as that fitted to one of the irrigation sprinklers such as 18A or 18B of the irrigation system 10 of FIGS. 1 and 2. The surface wave receiver controller 60 is, broadly speaking, configured to receive the surface wave signal 20 via the surface wave receiver 16 to activate the specified irrigation sprinkler such as 18A or more particularly its solenoid actuator valve 62 under predetermined conditions or at specific times at which irrigation is to be effected. The solenoid actuator valve may be associated with multiple, such as three or four, sprinklers.

The surface wave receiver controller 60 in this example includes an RF front end amplifier 64, a mixer IF and data receiver 66, an embedded processor 68 and a bidirectional switch 70. In the idle state where no surface wave signal is present only the RF amplifier 64 and the mixer IF 66 are powered and operate off a battery supply 65. In this example this rechargeable single cell battery is continuously recharged by solar cells on the top of the sprinkler or solenoid valve. Capacity is such that only a few hours sun a day are needed to top the battery off. One output of the mixer 66 is an analog received signal strength indicator (RSSI) line 67. When an incoming surface wave signal 20 is detected by the surface wave receiver 16 it is amplified by the RF amplifier 64 and converted to a baseband signal by the mixer IF 66. The RSSI line 67 then rises to a level set by the strength of the incoming signal 20. If the RSSI line 67 voltage rises sufficiently the incoming signal will activate a comparator 69 and provide power for an embedded processor 68. This embedded processor 68 then examines decrypted data 71 from the mixer IF 66 to see if it is required to take action. If the incoming detected code is correct or matches the unique ID for the receiver 16 then the embedded processor 68 activates a charge pump 73 which draws energy from the battery 65 and accumulates it in a capacitor bank 75. The embedded processor 68 monitors the voltage on the capacitor bank 75 and when it reaches a sufficiently high value operates a bidirectional switch 70 to dump energy in the latching solenoid coil 62 to turn it on or off.

The general steps involved in activating one or more irrigation sprinklers such as 18A and 18B (or solenoid-actuated control valves) of the irrigation system 10 of this embodiment are as follows:
1. The surface wave launcher controller such as 24A at specified irrigation times receives an electronic signal from its host satellite controller such as 21A;
2. The surface wave launcher controller 24A effectively converts that electronic signal to a surface wave signal 20 which is transmitted via the corresponding surface wave launcher such as 12A;
3. The surface wave signal 20 includes a unique identifier for one irrigation sprinkler such as 18A (or control valve dedicated to more than 1 sprinkler) to be activated and the surface wave receiver such as 16A for the nominated sprinkler(s) such as 18A receive and recognise the instruction to activate;
4. The nominated irrigation sprinkler such as 18A charges its capacitor to sufficient power to activate the corresponding solenoid such as 62 for opening of the irrigation sprinkler(s) such as 18A;
5. At a predetermined time following a sufficient period of irrigation, the surface wave launcher controller 24 sends a command via the surface wave signal 20 to pulse the solenoid 62 off and shut down the corresponding irrigation sprinkler such as 18A (or control valve).

Now that various embodiments of the present disclosure have been described in some detail, it would be apparent to those skilled in the art that the irrigation system and associated surface wave launcher have at least the following advantages:
1. The irrigation system which utilises a surface wave signal for control of irrigation sprinklers avoids the need for hard wiring between the satellite controller and the various irrigation sprinklers;
2. The wireless installation provides lower installation and maintenance costs;
3. The wireless installation is not vulnerable to lightning strikes which may otherwise damage a hard wired system and require replacement;
4. The irrigation system lends itself to retrofitting to existing systems such as satellite systems;
5. The transmission of a surface wave signal, and, in one embodiment, the subsurface component of surface waves, along the ground/air interface is understood to avoid the need for compliance with regulatory requirements applicable to air-borne electromagnetic transmissions;
6. The surface-bound wave of the described embodiment is understood to have energy losses of the inverse of distance, as opposed to air-borne transmission with losses of the inverse square of distance, requiring relatively low power for effective transmission.

Those skilled in the art will appreciate that the disclosure described herein is susceptible to variations and modifications other than those specifically described. For example, the specific system configuration may vary from that described which is more applicable to a golf course. For example, the irrigation system may have general domestic or irrigation application for any number or quantity of irrigation sprinklers. The surface wave receiver need not be constructed as specifically described but rather may be of any general construction which permits a surface wave signal to effectively activate an irrigation sprinkler with its associated surface wave receiver. All such variations and modifications are to be considered within the scope of the present disclosure, the nature of which is to be determined from the foregoing description.

1-24. (canceled)

25. An irrigation system comprising:
a surface wave launcher configured to be:
(i) located predominantly underground, and
(ii) controlled by an electronic control system to, under at least one predetermined condition, transmit a surface wave signal at a relatively low operating frequency; and
a surface wave receiver configured to be:
(i) located underground, and
(ii) operatively coupled to an irrigation sprinkler to activate the irrigation sprinkler in response to the low operating frequency surface wave signal.

26. The irrigation system of claim 25, wherein the surface wave launcher is configured to be located predominantly below a surface of the ground to effectively launch a ground component of the surface wave.

27. The irrigation system of claim 26, wherein the surface wave launcher includes a driven monopole which is configured to be located below the surface of the ground with a driven end at or near the surface of the ground.

28. The irrigation system of claim 25, wherein the electronic control system includes a surface wave launcher controller operatively coupled to the surface wave launcher and configured to transmit the surface wave signal to activate at least one of a plurality of irrigation sprinklers.

29. The irrigation system of claim 28, wherein the surface wave signal includes a unique identifier which corresponds to the at least one of the plurality of irrigation sprinklers which activates in response to the surface wave signal.

30. The irrigation system of claim 28, wherein the surface wave launcher controller is configured to couple to one of: a central controller, and a satellite controller, which under the at least one predetermined condition, transmits an electronic control signal to the surface wave launcher controller to cause the surface wave launcher to transmit the surface wave signal to the at least one of the plurality of irrigation sprinklers.

31. The irrigation system of claim 25, wherein the surface wave launcher includes a plurality of conductors connected in series in a meander line configuration.

32. The irrigation system of claim 31, wherein the surface wave launcher includes an opposing pair of grid elements, each providing a series of connections for the conductors which connect between the opposing pair of grid elements.

33. The irrigation system of claim 32, wherein the conductors are arranged in an inner and outer array spaced longitudinally by the pair of opposing grid elements and separated one of: radially and laterally, by an electromagnetic screen.

34. The irrigation system of claim 25, wherein the surface wave receiver is mounted to the irrigation sprinkler.

35. The irrigation system of claim 34, wherein the surface wave receiver includes a rod antenna element in the form of a ferrite rod, which is configured to detect the magnetic field of the surface wave signal.

36. The irrigation system of claim 34, wherein the surface wave receiver is of a serpentine configuration of conductors to permit both receiving and transmitting capabilities.

37. The irrigation system of claim 36, wherein the surface wave receiver is configured to communicate wirelessly with the surface wave launcher.

38. The irrigation system of claim 25, wherein the relatively low operating frequency is between 3 MHz and 30 MHz.

39. The irrigation system of claim 38, wherein the relatively low operating frequency is 13.56 MHz.

40. A surface wave launcher comprising:
a plurality of conductors connected in series in a meander line configuration;
an opposing pair of grid elements each providing a plurality of connections configured to interconnect the conductors that connect between the opposing pair of grid elements to form an outer array of the conductors and an inner array of the conductors; and
an electromagnetic screen located between the outer array of the conductors and the inner array of the conductors.

41. The surface wave launcher of claim 40, wherein the outer array of the conductors and the inner array of the conductors are arranged concentric with one another.

42. The surface wave launcher of claim 41, wherein the electromagnetic screen is shaped cylindrical and the concentric outer array of the conductors and the concentric inner array of the conductors are separated by the electromagnetic screen.

43. The surface wave launcher of claim 42, wherein the cylindrical electromagnetic screen is arranged concentric with the concentric outer array of the conductors and the concentric inner array of the conductors.

44. The surface wave launcher of claim 40, wherein the opposing pair of grid elements each include a printed circuit board having the plurality of connections configured to interconnect, in series, the outer array of the conductors and the inner array of the conductors.

45. The surface wave launcher of claim 40, which includes a ground conducting plate electrically connected to the electromagnetic screen at or adjacent one of the grid elements.

46. The surface wave launcher of claim 45, which includes a capacitive loading plate which is electrically connected to another of the conductors at or adjacent the opposing grid element.

47. The surface wave launcher of claim 46, wherein the respective conductors connected to a first driven element and the capacitive loading plate are both located in the outer array of the conductors.

48. The surface wave launcher of claim 40, which is configured to launch a surface wave signal across an air/ground boundary or interface where the surface wave signal remains coupled as an electromagnetic signal.

49. The surface wave launcher of claim 48, wherein the surface wave signal frequency is between 3 MHz and 30 MHz.

50. The surface wave launcher of claim 49, wherein the surface wave signal frequency is 13.56 MHz.
